(19) United States
(12) Patent Application Publication
(10) Pub. No.: US 2003/0086674 A1
(43) Pub. Date: May 8, 2003

(54) Optical components with reduced temperature sensitivity

(76) Inventors: Xiantao Yan, Pasadena, CA (US); Min Huang, Pasadena, CA (US)

Correspondence Address: TRAVIS DODD, 2490 HEYNEMAN HOLLOW, FALLBROOK, CA, 92028, US

(21) Appl. No.: 09/991,892

(22) Filed: Nov. 5, 2001

(51) Int. Cl. G02B 6/00; G02B 6/26

(52) U.S. Cl. 385/137; 385/13

(57) ABSTRACT

An optical component system is disclosed. The optical component system includes a holder holding an optical component having one or more waveguides. The optical component system also includes one or more compression members positioned between the holder and the optical component. The one or more compression members are configured to compress the optical component.

### BACKGROUND

1. Field of the Invention

The invention relates to one or more optical networking components. In particular, the invention relates to optical components having a reduced thermal sensitivity.

2. Background of the Invention

Optical networks often employ optical components that include one or more waveguides formed over a substrate. These optical components are often sensitive to temperature changes. For instance, the waveguide material often has an index of refraction that changes as a result of temperature changes. Further, the optical component often warps in response to temperature changes. This warping places strain on the waveguides that can cause the index of refraction of the waveguide to change. As a result, there are two mechanisms available for temperature changes to affect the index of refraction of the waveguides. These changes in index of refraction can affect how the light signals travel through the waveguides and can accordingly affect the performance of the component.

For the above reasons, there is a need for optical components with reduced thermal sensitivity.

### SUMMARY OF THE INVENTION

The invention relates to an optical component system. The optical component system includes a holder holding an optical component having one or more waveguides. The optical component system also includes one or more compression members positioned between the holder and the optical component. The one or more compression members are configured to compress the optical component.

The invention also relates to a method of fabricating an optical component system. The method includes obtaining a holder holding an optical component having one or more waveguides. The method also includes positioning one or more compression members between the optical component and the holder. The one or more compression members are configured to apply a compressive force to the optical component.

The one or more waveguides are associated with a wavelength shift. The compression applied by the one or more compression members over a temperature range of at least 20 to 30° C. can reduce the wavelength shift of at least one of the waveguides below the wavelength shift of the at least one waveguides when the compression is not applied applied. In some instances, the wavelength shift of the at least one waveguide is reduced by 50%, 70%, 80%, 90% or 95% and in some instances greater than 98%.

In one embodiment of the system, the compression members compress the optical component in a direction that is substantially parallel to a plane of the optical component.

In some instances, the one or more compression members include a material having a coefficient of thermal expansion greater than 1×10⁻⁵/° C. or 2×10⁻⁵/° C. The one or more compression members can be a metal.

Yet another embodiment of the invention relates to a method of operating an optical component. The method includes obtaining a holder holding an optical component having one or more waveguides. The method also includes applying a force against the holder and against the optical component in a direction opposite to the force applied against the holder. The force is applied so as to compress the optical component.

### BRIEF DESCRIPTION OF THE FIGURES

FIG. 1A is a top view of an optical component system having an optical component and a holder.

FIG. 1B is a cross section of the optical component system illustrated in FIG. 1A taken at the line labeled A.

FIG. 1C is a cross section of the optical component system illustrated in FIG. 1B taken at the line labeled A.

FIG. 2A is a close up view of a portion of the optical component system illustrated in FIG. 1B.

FIG. 2B is a close up view of a portion of the optical component system illustrated in FIG. 1C.

FIG. 3A is a cross section of an optical component system having compression members positioned adjacent to one side of the holder.

FIG. 3B is a cross section of an optical component system having compression members that are only positioned below the optical component.

FIG. 3C is a cross section of an optical component system having a single compression member.

FIG. 4A is topview of a cross section of an optical component system.

FIG. 4B is a cross section of the optical component shown in FIG. 4A taken at the line labeled A.

FIG. 4C is a cross section of the optical component shown in FIG. 4A taken at the line labeled B.

FIG. 5A is topview of a cross section of an optical component system.

FIG. 5B is a cross section of the optical component shown in FIG. 5A taken at the line labeled A.

FIG. 6A is a topview of an optical component system.

FIG. 6B is a cross sectional view of the optical component shown in FIG. 6A taken along the line labeled A.

FIG. 6C is a sideview of the optical component shown in FIG. 6B taken looking in the direction of the arrow labeled B.

FIG. 6D is a cross section of the optical component system of FIG. 6A through FIG. 6C adapted to have a single compression member.

FIG. 7 is a cross section of an optical component system having a plurality of spacers positioned between an optical component and a holder.

FIG. 8A is a topview of an optical component that is suitable for use with an optical component system according to the present invention.

FIG. 8B is a cross section of the optical component shown in FIG. 8A taken at any of the lines labeled A.

FIG. 9A through 9C illustrate a method of forming an optical component that is suitable for use with an optical component system.

FIG. 10A through FIG. 10D illustrate a method of forming an optical component system.

FIG. 11 is a force versus temperature graph that indicates the level of compressive force that needs to be applied to an optical component at a variety of different temperatures in order to maintain a substantially constant index of refraction in a waveguide on the optical component.

### DETAILED DESCRIPTION OF THE PREFERRED EMBODIMENT

The invention relates to an optical component system. The optical component system includes an optical component having one or more waveguides. Each of the one or more waveguides is associated with a wavelength shift. The optical component system also includes one or more compression members positioned between a holder and the optical component. The one or more compression members can be arranged so as to apply a force against the holder and a force against the optical component in a direction opposite to the force applied against the holder.

The one or more compression members can be selected so the amount of force applied to the optical component changes in response to temperature changes. For instance, the optical component and the one or more compression members can expand in response to increasing temperatures. When the holder is not substantially responsive to the temperature changes, the expansion of the optical component and the one or more compression members increases the force applied by the one or more compression members.

The index of refraction of the waveguides also changes in response to temperature changes. The one or more compression members can be selected to apply a force to the optical component that compensates for the temperature driven change in the index of refraction. For instance, the force applied to the optical component can induce a strain in the optical component that compensates for the change in index of refraction that occurs in response to temperature changes. As a result, the optical component system can have a reduce temperature sensitivity.

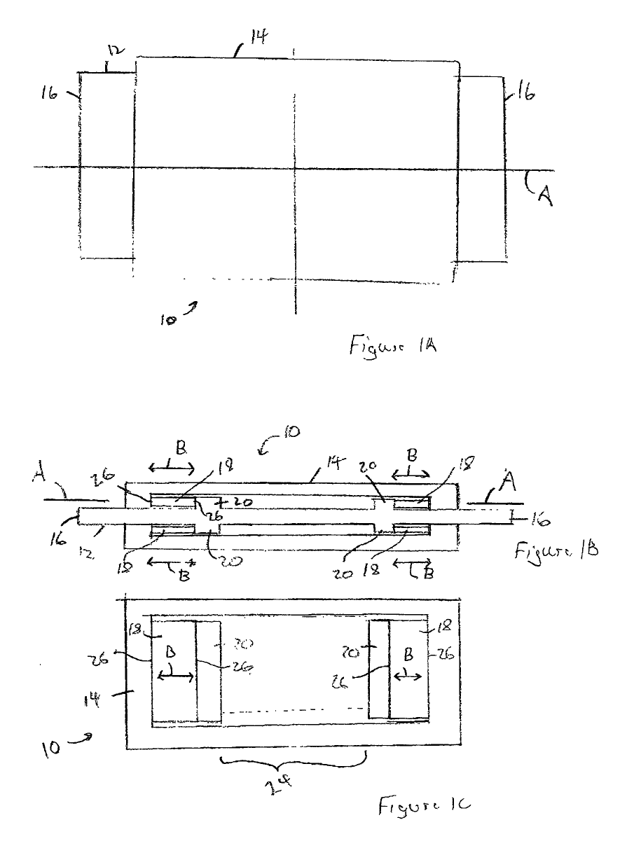

FIG. 1A through FIG. 1C illustrate an optical component system 10. FIG. 1A is a topview of the optical component system 10. FIG. 1B is a cross section of the optical component system 10 shown in FIG. 1A taken at the line labeled A and FIG. 1C is a cross section of the optical component system 10 shown in FIG. 1B taken at the line labeled A.

The optical component system 10 includes an optical component 12 held by a holder 14. Although not illustrated, the optical component 12 has one or more waveguides. One or more of the waveguides can end at a facet positioned at a side 16 of the optical component 12. Two sides 16 of the optical component 12 are shown as being positioned outside of the holder 14. As a result, facets positioned at these sides 16 can be easily coupled with an optical fiber for carrying light signals to and/or from the optical component 12. In some instances, the holder 14 can be configured to hold the component such that all or a portion of the sides 16 are flush with the sides 16 of the holder 14. Further, the holder 14 can be configured to hold the component such that all or a portion of the sides 16 are positioned within the holder 14. In these instances, the holder 14 can include one or more openings through which optical fibers can pass for coupling with the optical component 12.

Wavelength shift is a commonly used parameter for quantifying the temperature sensitivity of the waveguides on optical components 12. As noted above, the index of refraction of the waveguides changes as the temperature changes. The change in index of refraction causes a shift in the wavelength of light signals traveling through the waveguide. The wavelength shift indicates the amount of change in the wavelength of light traveling through the waveguide per change in the temperature of the waveguide material and is often expressed in terms of nm/° C. The wavelength shift for the waveguides of optical components 12 is often measured for typical wavelengths of optical networks. For instance, wavelength shifts are often measured at about 1550 nm.

The waveguide material by itself is associated with a wavelength shift. For instance, the wavelength shift of silica is about 0.01 nm/° C. while the wavelength shift for silicon is about 0.08 nm/° C. The wavelength shift associated with the waveguide material is not the same as the wavelength shift of a waveguide formed from the material. As noted above, strain applied to the waveguide can change the index of refraction of the waveguide. For instance, changes in temperature can cause the component to warp so a strain is applied to the waveguides. The strain causes a change in the index of refraction of the waveguide. This change in the index of refraction results in a strain induced change to the wavelength shift of the waveguide. As a result, the wavelength shift of a waveguide results from a combination of the wavelength shift associated with the waveguide material and a strain induced wavelength shift.

In some instances, the wavelength shift of a waveguide is not consistent along the length of the waveguide. As a result, the wavelength shift of a waveguide can refer to the average wavelength shift along the length of the waveguide. Additionally, the wavelength shift can be different at different temperatures.

The optical component system 10 can include one or more compression members 18 positioned between the holder 14 and the optical component 12. For instances, the optical component system 10 illustrated in FIG. 1A through FIG. 1C includes two flanges 20 extending above the optical component 12 and two flanges 20 extending below the optical component 12. A plurality of compression members 18 are seated against the holder 14 and against the optical component 12. In particular, each compression member 18 is seated against a flange 20. In some instances, the compression members 18 are not attached to the holder 14 or to the optical component 12.

As illustrated by the arrows labeled B, the compression members 18 apply a force on the holder 14 and a force on the optical component 12. The force applied to the holder 14 is applied in a direction opposite to the force applied to the optical component 12. The forces applied by the compression member 18 serve to compress the optical component 12. The compressive force applied to the optical component 12 is substantially parallel to the plane of the optical component 12. In particular, the compressive force is substantially parallel to a side 16 of the optical component 12 that is positioned between the top of the optical component 12 and the bottom of the optical component 12.

The one or more compression members 18 can be selected so the amount of force applied to the optical component 12 changes in response to temperature changes. For instance, the optical component 12 and the one or more compression members 18 can expand in response to increasing temperatures. The expansion of the optical component 12 and the one or more compression members 18 against one another increases amount of compressive force applied to the optical component 12. Accordingly, the amount of the compressive force applied to the optical component 12 increases as the temperature increases.

The one or more compression members 18 are selected so the amount of compressive force applied to the optical component 12 as a function of temperature compensates for the change in the index of refraction of at least one of the waveguides as a function of temperature. As a result, the one or more compression members 18 reduce the wavelength shift associated with at least one of the waveguides on the optical component 12.

Although the wavelength shift is often substantially constant over a temperature range of about 0° C. to 80° C., the wavelength shift can be a function of temperature. The optical components are generally employed at a temperature range of at least 20° C. to 30° C. Accordingly, the compression members are generally selected so the wavelength shift of the one or more waveguides is reduced over a temperature range of at least 20° C. to 30° C. Because optical components can be employed over a larger temperature range, many optical networking companies require that the wavelength shift be reduced over larger temperature ranges such as 10° C. to 70° C. or 0° C. to 80° C. The compression members can often reduce the wavelength shift over a temperature range of at least 10° C. to 70° C. or 0° C. to 80° C.

In some instances, the compression members 18 are not attached to the holder 14. As noted above, the compression member 18 can change size in response to temperature changes. When the compression members 18 are not attached to the holder 14, the difference in the coefficient of thermal expansion of the holder 14 and the compression member 18 does not cause additional stress to be placed on the compression member 18 or the holder 14 in response to temperature changes.

In some instances, the optical component 12 is not attached to the holder 14. The optical component 12 also changes size in response to temperature changes. When the optical component 12 is not attached to the holder 14, the difference in the coefficient of thermal of the holder 14 and the optical component 12 does not cause additional stresses to be placed on the optical component 12 in response to temperature changes.

In some conditions, the one or more compression members 18 do not apply a force to the optical component 12. For instance, when the temperature drops, the compression member 18 can contract in size. The contraction can be enough that the compression member 18 no longer apply a force to the optical component 12. Further, the contraction can be enough that one or more of the compression member 18 pulls away from the optical component 12 or from the holder 14. The optical component system 10 can be constructed such that the compression members 18 apply a compressive force to the optical component 12 at temperatures higher than 10° C., 0° C., −10° C. or −20° C. Additionally, the optical component system 10 can be constructed such that the compression members 18 do not apply a compressive force to the optical component 12 at temperatures less than 10° C., 0° C., −10° C. or −20° C.

In some instances, the ends 26 of a compression members 18 are coupled with optical component 12 and the holder 14. When ends 26 of a compression member 18 are coupled with an optical component 12, the temperature induced contraction of the compression member 18 and the optical component 12 can place the optical component 12 under tension.

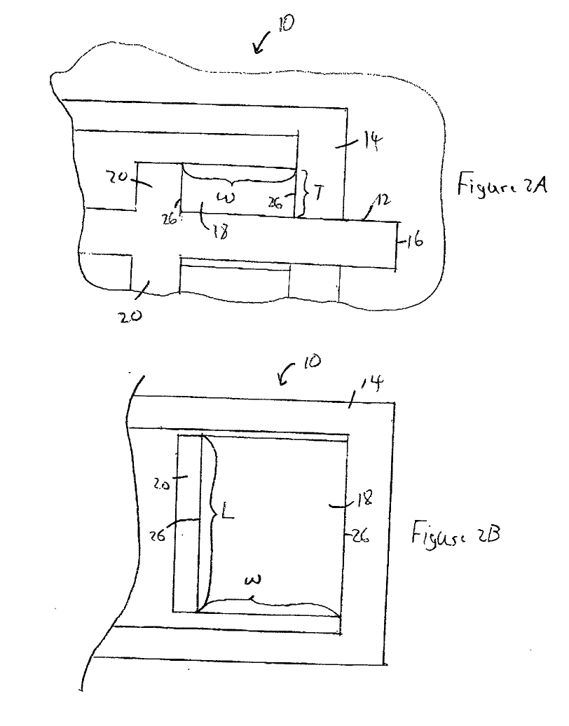

As shown in FIG. 2A and FIG. 2B, each compression member 18 is associated with a thickness labeled T, a width labeled W and a length labeled L. FIG. 2A is a closeup view of a portion of FIG. 1B and FIG. 2B is a closeup view of a portion of FIG. 1C. The various dimensions are selected to achieve the desired force versus temperature profile. For instance, increasing the value of the width increases the change in the amount of force applied per degree temperature. Increasing the thickness increases the amount of force that a compression member 18 can apply without bending. Increasing the length can increase the uniformity of the force applied by a compression member 18 along a side 16 of the optical component 12.

The materials from which the one or more compression members 18 are constructed can also be selected to provide a particular force versus temperature response. For instance, materials with a higher coefficient of thermal expansion can provide a higher change in the amount force applied to the optical component 12 per degree of temperature change. When the optical component 12 includes waveguides having an increased temperatures sensitivity such as silicon waveguide, the compression member 18 can have a coefficient of thermal expansion greater than 2×10⁻⁶/° C., 1×10⁻⁵/° C. or 2×10⁻⁵/° C. When the optical component 12 includes waveguides having a lower temperatures sensitivity such as silica waveguide, the compression member 18 can have a lower coefficient of thermal expansion. Examples of materials for the compression member 18 include, but are not limited to, aluminum, copper and polyimide.

The holder 14 can be rigid in order to resist bending in response to the force applied by the compression member 18. In some instances, the holder 14 preferably has a lower coefficient of thermal expansion than the optical component 12. When the coefficient of thermal expansion of the holder 14 is the same as or exceeds the coefficient of thermal expansion of the optical component 12, the compressive force applied by the compression member 18 can remain substantially constant with changing temperature or can decrease with increasing temperature. Suitable materials for the holder 14 include, but are not limited to, Invar, AIN and SiN.

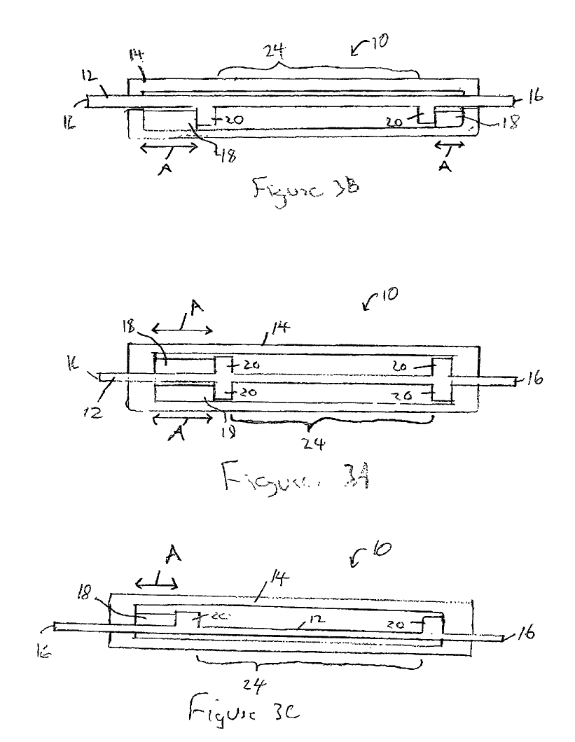

The compression member 18 can be positioned in contact with only one side of the holder 14 as illustrated in FIG. 3A. The optical component 12 includes two flanges 20 extending above the optical component 12 and two flanges 20 extending below the optical component 12. A compression member 18 positioned in contact with the holder 14 is seated against a flange 20 positioned over the optical component 12. A compression member 18 positioned in contact with the holder 14 is seated against a flange 20 positioned beneath the optical component 12. Additionally, a flange 20 positioned over the optical component 12 is seated against the holder 14 and a flange 20 positioned beneath the optical component 12 is seated against the holder 14. As illustrated by the arrows labeled A, the compression member 18 can be configured to place a force on the holder 14 and on the optical component 12 in a direction opposite to the direction of the force placed on the holder 14. Because the flanges 20 seated against the holder 14 are effectively immobilized relative to the holder 14, the forces applied on the optical component 12 by the compression member 18 place a compressive force on the optical component 12.

The effect of the flange 20 being seated against the holder 14 can also be achieved by attaching the optical component 12 to the holder 14. For instance, the portion of the optical component 12 adjacent to both the flange 20 and the holder 14 can be epoxied to the optical component 12. As a result, attaching a portion of the optical component 12 to the holder 14 can also be employed to immobilized a portion of the optical component 12 relative to the holder 14.

Compression members 18 positioned above and below the optical component 12 can reduce warping of the optical component 12. For instance, when the compressive force applied by the compression member 18 positioned over the optical component 12 is the same as the compressive force applied by the compression member 18 positioned below the optical component 12, the forces applied by the compression member 18 is balanced and the compression member 18 do not cause warping of the optical component 12.

Many optical components 12 tend to warp in response to temperature changes. The compression member 18 can be selected to reduce the tendency of the optical component 12 to warp. For instance, when the optical component 12 tends to warp such that the middle of the optical component 12 moves upward in response to increasing temperatures, the compression member 18 above the optical component 12 can be selected to provide a larger compressive force than the compression member 18 below the optical component 12. The larger force provide by the compression member 18 over the optical component 12 can place a leverage on the optical component 12 that drives the middle of the optical component 12 downward. The downward force on the middle counters the natural warping tendency of the optical component 12.

In some instances, the compression members 18 are only positioned above the optical component 12 or below the optical component 12 to provide a thinner optical component system 10. For instance, FIG. 3B shows compression members 18 positioned below the optical component 12. The optical component 12 includes two flanges 20 extending below the optical component 12. The compression members 18 are seated against the holder 14 and against the flanges 20. As illustrated by the arrow labeled A, each compression members 18 can be configured to place a force on the holder 14 and on the optical component 12 in a direction opposite to the direction of the force placed on the holder 14.

The optical component system 10 can include a single compression member 18 as shown in FIG. 3C. The optical component 12 includes flanges 20 extending above the optical component 12. A compression member 18 is seated against the holder 14 and a flange 20. The other flange 20 is seated against the holder 14. As illustrated by the arrow labeled A, the compression member 18 can be configured to place a force on the holder 14 and on the optical component 12 in a direction opposite to the direction of the force placed on the holder 14. Because the flange 20 seated against the holder 14 is effectively immobilized relative to the holder 14, the force applied to the optical component 12 by the compression member 18 place a compressive force on the optical component 12.

As noted above, some optical components 12 have a natural tendency to warp in response to temperature changes. When all of the compression members 18 are positioned above or below the optical component 12 as shown in FIG. 3B or FIG. 3C, the compression member 18 can be positioned on the side 16 of optical component 12 where the middle of the optical component 12 tends to move in response to increasing temperatures. For instance, when the optical component 12 tends to warp such that the middle of the optical component 12 moves upward in response to increasing temperatures, the compression member 18 can be position over the optical component 12. The leverage resulting from the one or more compression members 18 being positioned above or below the optical component 12 can counter the natural tendency to warp.

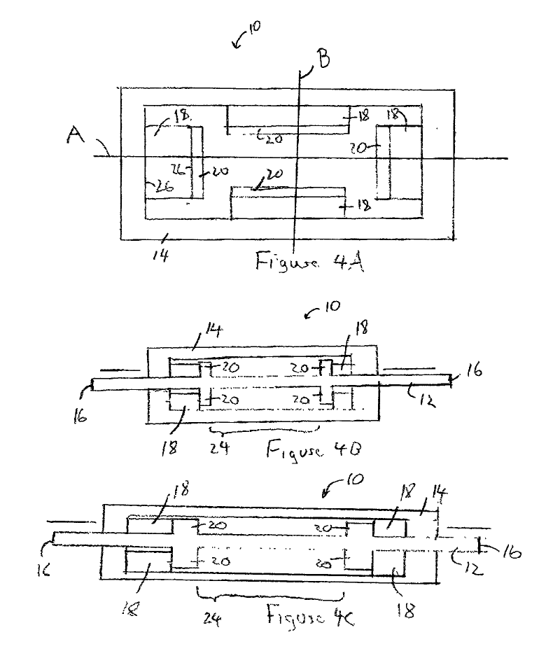

The compression member 18 can be arranged so as to compress the optical component 12 in more than one direction. FIG. 4A through FIG. 4C illustrate and optical component system 10 having compression members 18 arranged so as to compress the optical component 12 in two directions. FIG. 4A is cross section of an optical component system 10 similar to the cross sectional view shown in FIG. 1C. FIG. 4B is a cross section of the optical component system 10 shown in FIG. 4A taken at the line labeled A and FIG. 4C is a cross section of the optical component system 10 shown in FIG. 4A taken at the line labeled B. The optical component system 10 includes compression members 18 configured to compress the optical component 12 along the line labeled A and compression members 18 configured to compress the optical component 12 along the line labeled B. As a result, the optical component 12 is compressed in more than one direction. Increasing the number of directions from which the optical component 12 is compressed can increase the uniformity of the compression across the optical component 12 and can accordingly improve the temperature response of the optical component 12.

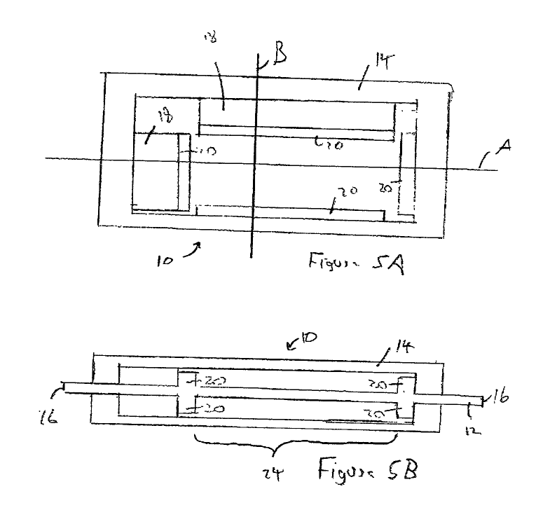

Other embodiments of the optical component system 10 illustrated above can be adapted to compress the optical component 12 from different directions. For instance, FIG. 5A through FIG. 5B illustrate the optical component system 10 of FIG. 3B adapted to compress the optical component 12 from two directions. FIG. 5A is topview of a cross section of an optical component system 10. FIG. 5B is a cross section of the optical component 12 shown in FIG. 5A taken at the line labeled A. The optical component system 10 includes compression members 18 configured to compress the optical component 12 along the line labeled A and compression member 18 configured to compress the optical component 12 along the line labeled B. As a result, the optical component 12 is compressed in more than one direction.

Because the compression members 18 are seated against the flanges 20 on the optical component system 10 of FIG. 1A through FIG. 5C, the portion of the optical component 12 that is compressed by the compression member 18 is located between the flanges 20. Accordingly, the flanges 20 define the temperature compensated region 28 of the optical component system 10. The portion of the optical component 12 positioned outside of the temperature compensated region 28 will not experience substantial temperature sensitivity reduction. Accordingly, the optical component system 10 is generally designed so the portion of the optical component 12 that is most sensitive to temperature changes is positioned in the temperature sensitive region. For instance, arrayed waveguide gratings 56 often provide the functionality to optical components 12 such as demultiplexers, dispersion compensators and filters. However, the functionality provided by the arrayed waveguide grating 56 can be sensitive to temperature changes. Accordingly, when the optical component 12 includes an arrayed waveguide grating 56, the optical component system 10 is generally designed such that the arrayed waveguide grating 56 is positioned in the temperature compensated region 28.

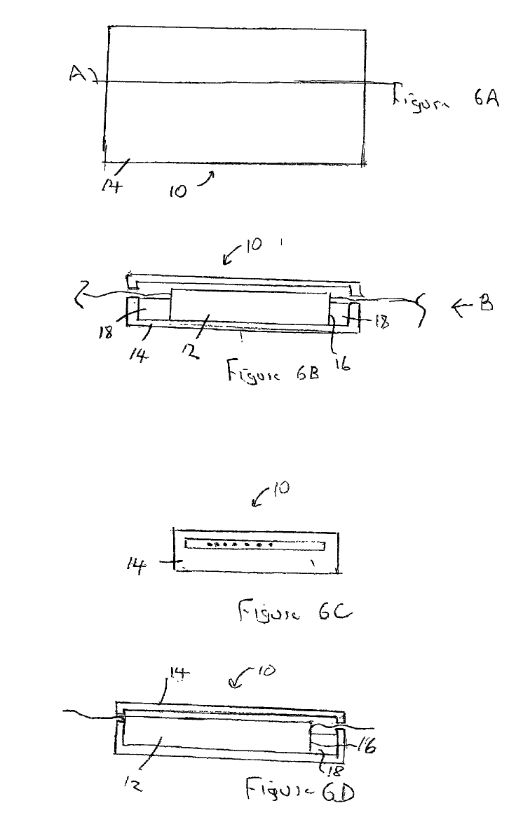

The size of the temperature compensated region 28 can be increased by applying the compressive force directly to one or more side 16 of the optical component 12. FIG. 6A through FIG. 6C illustrate an optical component system 10 having compression members 18 configured to apply a compressive force to the sides 16 of the optical component 12. FIG. 6A is a topview of the optical component system 10. FIG. 6B is a cross sectional view of the optical component 12 shown in FIG. 6A taken along the line labeled A and FIG. 6C is a sideview of the optical component 12 shown in FIG. 6B taken looking in the direction of the arrow labeled B.

A plurality of compression members 18 are seated between the holder 14 and the optical component 12. One or more optical fibers 26 can be coupled with the optical component 12 for carrying light signals to and/or from the optical component 12. The one or more optical fibers can pass through one or more openings 28 in the holder 14.

The embodiment of the optical component system 10 illustrated in FIG. 6A through FIG. 6C can have compression members 18 configured to apply a compressive force from more than on direction. Further, the compression member 18 need not be positioned on opposing sides 16 of the optical component 12 as illustrated in FIG. 6D.

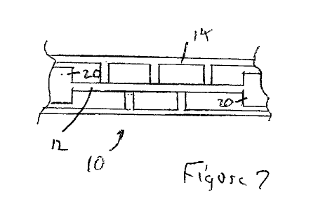

The optical component system 10 can include one or more spacers 30 as shown in FIG. 7. The spacers can be integral with the holder 14 or can be positioned between the top and/or bottom of the optical component 12 and the holder 14. The spacers can be positioned so as to reduce warping of the optical component 12 in response to temperature changes. Reducing that amount of warping that occurs in response to temperature change can reduce the temperature sensitivity of the optical component 12. The spacers can be attached to the holder 14, integral with the holder 14, attached to the optical component 12 or integral with the optical component 12. In some instances, the spacers are not immobilized relative to either the holder 14 or the optical component 12.

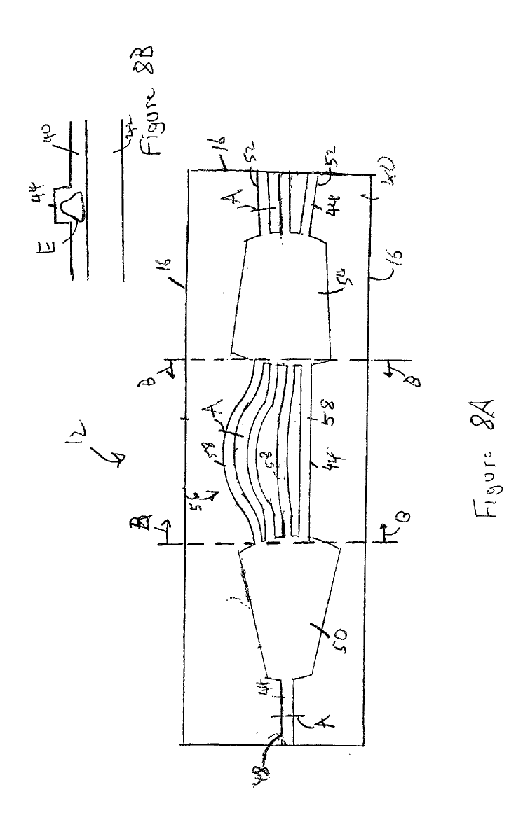

FIG. 8A through FIG. 8B illustrate an example of an optical component 12 construction that is suitable for use with an optical component system 10. FIG. 8A is a topview of the optical component 12 and FIG. 8B is a cross section of the optical component 12 shown in FIG. 8A taken at any of the lines labeled A.

The optical component 12 includes a light transmitting medium 40 positioned over a base 42. The light transmitting medium 40 includes a ridge 44 that defines a portion of the light signal carrying region 46 where light signals are constrained. Suitable light transmitting media include, but are not limited to, silicon, polymers and silica. The portion of the base 42 adjacent to the light signal carrying region 46 is configured to reflect light signals from the light signal carrying region 46 back into the light signal carrying region 46. As a result, the base 42 also defines a portion of the light signal carrying region 46. The line labeled E illustrates the profile of a light signal carried in the light signal carrying region 46 of FIG. 8B.

Although not shown, a cladding layer can be optionally be positioned over the light transmitting medium 40. The cladding layer can have an index of refraction less than the index of refraction of the light transmitting medium 40 so light signals from the light transmitting medium 40 are reflected back into the light transmitting medium 40.

The illustrated optical component 12 has a demultiplexer with an input waveguide 48 in optical communication with an input star coupler 50 and a plurality of output waveguides 52 in optical communication with an output star coupler 54. The optical component 12 also includes an arrayed waveguide grating 56 having a plurality of array waveguides 58 that provide optical communication between the input star coupler 50 and the output star coupler 54. The length of each array waveguide 58 is different and the length differential between adjacent array waveguides 58, ΔL, is a constant.

During operation of the optical component 12, light signals from the first waveguide enter the input star coupler 50. The input star coupler 50 distributes the light signal to a plurality of the array waveguides 58. The light signals travel through the array waveguides 58 into the output star coupler 54. Because the adjacent array waveguides 58 have different lengths, the light signal from each array waveguide 58 enters the output star coupler 54 in a different phase. The phase differential causes the light signal to be focused at a particular one of the output waveguides 52. The output waveguide 52 on which the light signal is focused is a function of the wavelength of light of the light signal. Accordingly, light signals of different wavelengths are focused on different output waveguides 52. As a result, each output waveguide 52 carries a light signal of a different wavelength.

The illustrated optical component 12 is not proportional and the number of waveguides is not necessarily representative. For instance, four array waveguides 58 are shown but demultiplexers often include a different number of array waveguides 58 and can include as many as several tens or hundreds of array waveguides 58. Further, the demultiplexer can include more than three output waveguides 52 or as few as one.

As described above, the arrayed waveguide grating 56 provides the optical component 12 with the demultiplexing functionality. However, the function provided by the array waveguide grating 56 can be sensitive to temperature. For instance, changes in temperature can cause the index of refraction of the array waveguides 58 to change and can accordingly change the effective length of the array waveguides 58. The change in the effective length of the array waveguides 58 changes the value of the length differential between adjacent array waveguides 58, ΔL. The change in the length differential between adjacent array waveguides 58, ΔL, causes the location of the light signals to shift relative to the output waveguides 52. As a result of the shift, a particular wavelength of light may be dropped from a particular output waveguide 52 and in some instances can appear on another output waveguide 52. Hence, the demultiplexing functionality changes as a result of the effects of temperature on the arrayed waveguide grating 56.

Because the demultiplexing functionality changes as a result of the effects of temperature on the arrayed waveguide grating 56, the optical component system 10 is configured such that the arrayed waveguide grating 56 is positioned in the temperature compensated region 28. For instance, the dashed lines on FIG. 8A can indicate the location of the temperature compensated region 28. Because the arrayed waveguide grating 56 is positioned in the temperature compensated region 28, the effects of temperature changes on the performance of the arrayed waveguide grating 56 are reduced. The reduced temperature effects can reduce the shifting of the light signals relative to the output waveguides 52.

In some instances, the temperature compensated region 28 is positioned such that the direction of the compressional force is substantially aligned with the longitudinal axis of the waveguides. For instance, the arrows labeled B indicates the direction of the compressive force applied by the compression member 18. The direction of compression is substantially aligned with the longitudinal axis of the array waveguides 58. Accordingly, the array waveguides 58 are compressed along their longitudinal axis. Applying the compressive force along the longitudinal axis of a waveguide can provide better index of refraction uniformity than applying the compressive force laterally across the waveguide.

Although the optical component 12 of FIG. 8A and FIG. 8B is disclosed in the context of a demultiplexer, other optical components 12 having arrayed waveguide gratings 56 include, but are not limited to dispersion compensator and optical filters. An example of an optical filter having an arrayed waveguide grating 56 is taught in U.S. patent application Ser. No. 09/845685, filed on Apr. 30, 2001 entitled “Tunable Filter” and incorporated herein in its entirety. Examples of a dispersion compensator having an arrayed waveguide grating 56 is taught in U.S. patent application Ser. No. 09/872473, filed on Jun. 1, 2001 entitled “Tunable Dispersion Compensator” and U.S. patent application Ser. No. 09/924403, filed on Aug. 6, 2001, entitled “Optical Component Having a Light Distribution Component With a Functional Region” each of which are incorporated herein in their entirety. These optical components 12 can also exhibit a reduced temperature sensitivity when employed in conjunction with the disclosed optical component system 10. Further, many optical components 12 that do not employ arrayed waveguide gratings 56 can benefit from the reduced temperature sensitivity provided by the optical component system 10.

FIG. 8A and FIG. 8B illustrate an optical component 12 having a plurality of ridge 44 waveguides, suitable optical components 12 can have other waveguide types such as buried channel waveguides and strip waveguides.

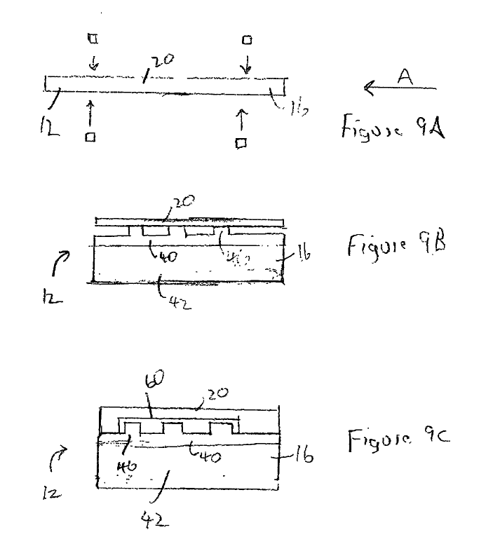

FIG. 9A through FIG. 9C illustrate a method of forming an optical component 12 that is suitable for use with an optical component system 10 according to the present invention. One or more flanges 20 can be coupled to an optical component 12 as shown in FIG. 9A. The flanges 20 can be coupled using an adhesive such as an epoxy. Suitable materials for the flange 20 include, but are not limited to, silicon, silica, SiN and AIN.

When the optical component 12 is constructed as illustrated in FIG. 8A through FIG. 8B, the flanges 20 can be coupled to the tops of the ridges 44 as illustrated in FIG. 9B. FIG. 9B is a sideview of the optical component 12 shown in FIG. 9A taken in the direction of the arrow labeled A. FIG. 9C shows an alternative to coupling the flanges 20 to the top of the ridge 44. The flange 20 can include one or more grooves 60 sized to accommodate the ridges 44. The flange 20 is coupled to the portion of the optical component 12 adjacent to the ridges 44. Although the groove 60 shown in FIG. 9C is sized to accommodate more than one ridge 44. The flange 20 can include a plurality of grooves 60 that are each sized to accommodate one ridge 44.

In some instances, the flanges 20 can be integral with the optical component 12 and the flanges 20 need not be attached to the optical component 12. Further, embodiments of the optical component 12 such as the embodiment disclosed in FIG. 6A through FIG. 6D do not require flanges 20.

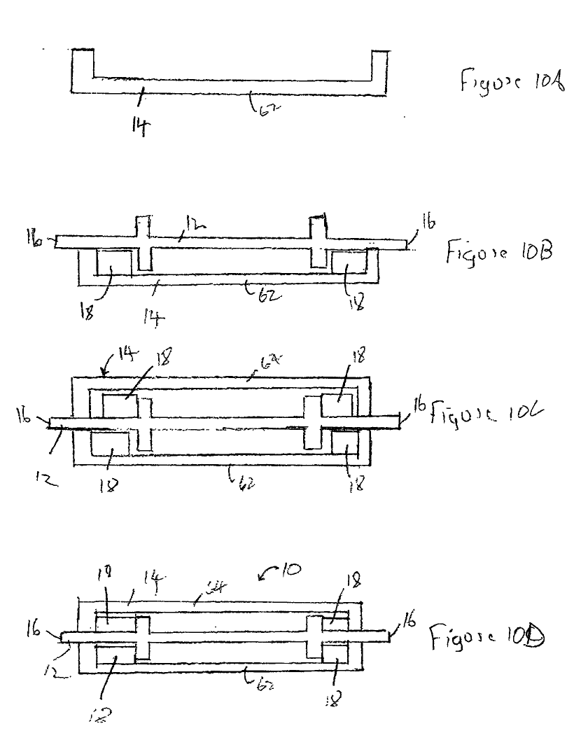

FIG. 10A through FIG. 10C illustrate a method of forming an optical component system 10 using an optical component 12 constructed according to FIG. 9A. A holder base 62 is obtained as shown in FIG. 10A.

Compression members 18 are seated in the holder base 62 and the optical component 12 positioned on the base as shown in FIG. 10B. The compression members 18 are at a reduced temperature before being positioned in the holder base 62. The reduced temperature causes the compression member 18 to contract to a reduced size. The reduced size allows the optical component 12 and the compression member 18 to be positioned in the holder base 62 without the compression member 18 applying a substantial force to the optical component 12. To illustrate this point, a gap is shown between the flanges 20 and the compression member 18. In some instances, the temperature of the optical component 12 can also be reduced to increase the gap between the flanges 20 and the compression member 18. Alternatively, the temperature of the optical component 12 can be reduced while the compression members 18 remain at room temperature. When the compression members 18 are constructed from Al, a suitable reduced temperature includes, but is not limited to, −70° C. to −40° C. A suitable reduced temperature for the optical component 12 includes, but is not limited to, −60° C. to −30° C.

Compression members 18 are seated on optical component 12 and a holder cover 64 coupled with a holder base 62 as shown in FIG. 10C. The compression member 18 can be at a reduced temperature before being positioned on the optical component 12. The reduced temperature can provide a gap between the optical component 12 and the holder 14 as illustrated in FIG. 10C. Suitable means for coupling the holder cover 64 to the holder base 62 include, but are not limited to, use of adhesives and epoxies.

The optical component system 10 is allowed to come to room temperature as shown in FIG. 10D. The increased temperature allows the compression member 18 and the optical component 12 to expand. The expansion causes the gap to close and causes the compression member 18 to place the compressive force on the optical component 12.

The size of the gap can determine the amount of force applied to the optical component 12 at higher temperatures. For instance, the gap size increases as the width of the compression member 18 positioned between the holder 14 and the optical component 12 decreases. When the temperature of the optical component system 10 is elevated to a particular temperature, the amount of force applied to the optical component 12 at the elevated temperature increases as the size of the gap before elevating the temperature decreases.

The methods of FIG. 9A through FIG. 10D can be adapted to forming the other embodiments of the optical component 12 illustrated above.

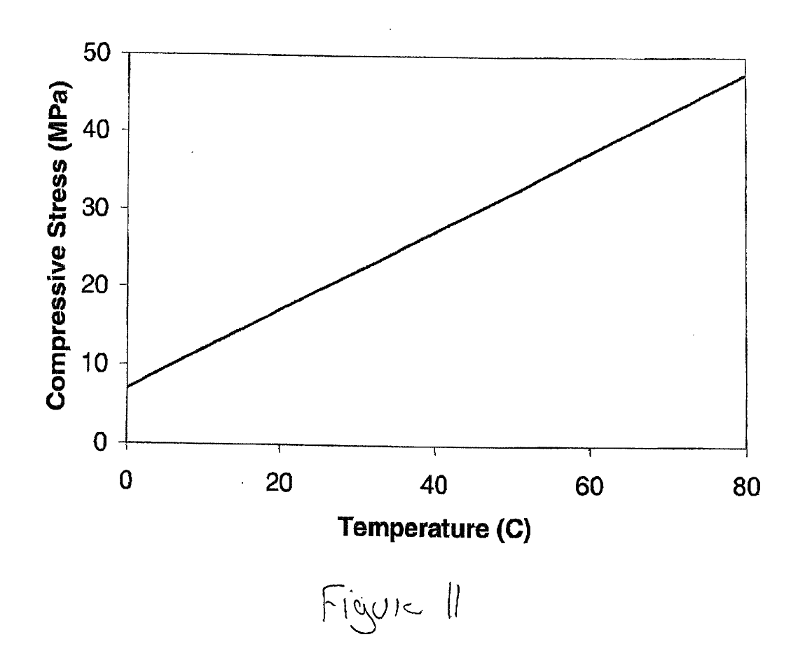

In one embodiment of a method for selecting the compression member 18, the compressive force that is required to maintain a desired index of refraction over a particular temperature range is identified. For instance, FIG. 11 is a graph showing the needed compressive stress versus temperature can be generated for a particular index of refraction. The optical component 12 used to generate FIG. 11 is constructed according to FIG. 8A and FIG. 8B. The optical component 12 has a base having a layer of silica with a thickness of 0.4 μm over a silicon substrate having a thickness of 525 μm. The light transmitting medium 40 is silicon having a thickness of 10 μm at each ridge 44 and 4 μm between the ridges 44. The optical component 12 includes 40 array waveguides 58.

Simulation methods can be employed to identify the size and materials of the compression member 18 that can best provide the desired amount of compressive force over the desired temperature range. A suitable temperature range includes, but is not limited to, 20° C. to 30° C., because many optical components 12 are generally used within this temperature range or a temperature range of 10° C. to 70° C. or 0° C. to 80° C. because the wavelength shift standards of many optical networking companies fall within this range. In some instances, the one or more compression members 18 are configured to apply a compressive stress of at least 5 MPa, 10 MPa or 20 MPa at a temperature above 10° C.

Optical components 12 having silicon waveguides can have a wavelength shift as greater than 0.06 nm/° C. or greater than 0.08 nm/° C. Simulations have shown that when these optical components 12 are incorporated into the optical component 12 system 10, the wavelength shift can be reduced by greater than 50%, 70% or 90% and in some instances greater than 95%. Silica is associated with a lower wavelength shift than is silicon. Optical components 12 having silica waveguides can have a wavelength shift as low as 0.02.nm/° C. or 0.01 nm/° C. Simulations have shown that when these optical components 12 are incorporated into the optical component system 10, the wavelength shift can be reduced by greater than 60%, 80% or 95% and in some instances greater than 98%.

### EXAMPLE 1

An example of an optical component system 10 includes an optical component 12 constructed according to FIG. 8A and FIG. 8B. The optical component 12 includes a base having a layer of silica having a thickness of 0.4 μm over a silicon substrate having a thickness of 525 μm. The light transmitting medium 40 is silicon having a thickness of 10 μm at each ridge 44 and 4 μm between the ridges 44. The optical component 12 includes 40 array waveguides 58. Two flanges 20 are attached to the bottom of the optical component 12 and two flanges 20 are attached to the top of the optical component 12 in accordance with FIG. 1 B. The flanges 20 are each constructed from silicon. The holder 14 is constructed from silica. A compression member 18 is positioned between each flange 20 and the holder 14. The compression members 18 are constructed from aluminum. The thickness of each flange 20 is 17 mm, the width of each flange 20 is 1 mm and the length of each flange 20 is 30 mm. The wavelength shift associated with the array waveguides 58 without the compressive force applied by the compression member 18 is about 5-6 nm over a temperature range of about 10° C. to 70° C. Simulations show that the wavelength shift associated with the array waveguides 58 with the compressive force applied by the compression member 18 is about 0.6 nm over a temperature range of about 10° C. to 70° C.

Although the above embodiments show a single compression member 18 configured to apply a force to the optical component 12 in a particular direction, more than one compression member 18 can be configured to apply a force in a particular direction. For instance, a plurality of compression member 18 can be positioned along one side 16 of the optical component 12. Further, each of the compression member 18 need not be rectangular as is illustrated above. For instance, one or more sides of the compression member 18 can be arced. The use of an arc can help to increase the uniformity of the compressive force applied to the optical component 12.

Although the optical component system 10 is disclosed in the context of applying a compressive force in the plane of the optical component 12, one or more compression members 18 can be positioned between the top of the optical component 12 and the holder 14 and/or between the bottom of the optical component 12 and the holder 14 to apply a compressive force to the optical component 12 perpendicular to the plane of the optical component 12. Further, one or more compression members 18 can be positioned so as to apply a compressive force at other angles relative to the plane of the optical component 12.

The optical component system 10 can employ optical components 12 having other temperature sensitivity reduction mechanisms. For instance, the optical component 12 can include a warping members designed to warp the optical component 12 so as to reduce the wavelength shift of the optical component 12. An example of a single layer warping member is taught in U.S. patent application Ser. No. 09/884885, filed on Jun. 18, 2001 entitled “Optical Components With Controlled Temperature Sensitivity” and incorporated herein in its entirety. An example of an optical component 12 that increases warping symmetry to provide a reduced temperature sensitivity is taught in U.S. patent application serial number (Not Yet Assigned), filed on Aug. 24, 2001 entitled “Optical Component Having Improved Warping Symmetry” and incorporated herein in its entirety. The use of these additional temperature sensitivity reduction methods in conjunction with the optical component system 10 can further reduce the temperature sensitivity of the optical component 12.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. An optical component system, comprising:
a holder holding an optical component having one or more waveguides; and
one or more compression members positioned between the holder and the optical component, the one or more compression members configured so as to compress the optical component.

2. The system of claim 1, wherein the compression applied by the one or more compression members at a temperature in a range of 20° C. to 30° C. reduces a wavelength shift of at least one of the waveguides below the wavelength shift of the at least one waveguide without the compression applied by the one or more compression members.

3. The system of claim 2, wherein the compression applied by the one or more compression members at a temperature in a range of 20° C. to 30° C. reduces the wavelength shift of at least one of the waveguides by 50% below the wavelength shift of the at least one waveguide without the compression applied by the one or more compression members.

4. The system of claim 2, wherein the compression applied by the one or more compression members at a temperature in a range of 20° C. to 30° C. reduces the wavelength shift of at least one of the waveguides by 80% below the wavelength shift of the at least one waveguide without the compression applied by the one or more compression members.

5. The system of claim 1, wherein the compression members compress the optical component in a direction that is substantially parallel to a plane of the optical component.

6. The system of claim 1, wherein the one or more compression members is constructed of a material having a coefficient of thermal expansion greater than 5×10⁻⁶.

7. The system of claim 1, wherein the one or more compression members is a metal.

8. The system of claim 1, wherein the compression members is not attached to the holder.

9. The system of claim 1, wherein the optical component is not attached to the holder.

10. The system of claim 1, wherein a portion of a compression members positioned adjacent to a bottom of the holder is not attached to the holder.

11. The system of claim 1, wherein a portion of a compression members positioned adjacent to a top of the holder is not attached to the holder.

12. The system of claim 1, wherein the one or more compression members are positioned over the optical component.

13. The system of claim 1 wherein the one or more compression members are positioned under the optical component.

14. The system of claim 1, wherein the one or more compression members are positioned adjacent to one side of the holder.

15. The system of claim 1, wherein the one or more compression members are configured to compress the optical component in more than one direction.

16. A method of fabricating an optical component system, comprising:
obtaining a holder holding an optical component having one or more waveguides; and
positioning one or more compression members between the optical component and the holder, the one or more compression members configured to apply a compressive force to the optical component at temperatures above −10° C.

17. The method of claim, 16, wherein the compression applied by the one or more compression members at a temperature in a range of 20° C. to 30° C. reduces a wavelength shift of at least one of the waveguides below the wavelength shift of the at least one waveguide without the compression applied by the one or more compression members.

18. The method of claim 17, wherein the compression applied by the one or more compression members at a temperature in a range of 20° C. to 30° C. reduces the wavelength shift of at least one of the waveguides by 50%.

19. A method of operating an optical component, comprising:
obtaining a holder holding an optical component having one or more waveguides; and
applying a force against the holder and against the optical component in a direction opposite to the force applied against the holder, the force being applied so as to compress the optical component.

20. The method of claim 19, wherein the optical component is compressed such that a wavelength shift of at least one of the waveguides at a temperature in a range of 20° C. to 30° C. is reduced below the wavelength shift of the at least one waveguide without the compression applied by the one or more compression members.

21. The system of claim 20, wherein the optical component is compressed at a temperature in a range of 20° C. to 30° C. such that the wavelength shift of at least one of the waveguides is reduced by 50%.
